(19) United States
(12) Patent Application Publication
(10) Pub. No.: US 2002/0080715 A1
(43) Pub. Date: Jun. 27, 2002

(54) WDM signal monitoring

(76) Inventors: Jean-Pierre Weber, Solna (SE); Paul Weber, Auderghem (BE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/880,960

(22) Filed: Jun. 15, 2001

(30) Foreign Application Priority Data
Jun. 16, 2000 (GB) 0014837.9

(51) Int. Cl. H04L 5/20; H04J 15/00

(52) U.S. Cl. 370/200

(57) ABSTRACT

A system for monitoring WDM channels in an optical system includes a phased array optical wavelength demodulator (phasar). The phasar is controlled to vary the effective optical length of the waveguides in the array such that a particular wavelength signal can be output for monitoring.

The present invention relates to systems for monitoring wavelength division multiplexed signals.

### DESCRIPTION OF THE RELATED ART

Wavelength-division multiplexing (WDM) is an attractive way to increase the capacity of optical fibre lines, because it uses the large wavelength (frequency) domain available in an optical fibre by assigning different wavelengths to different channels. This requires the use of devices to perform multiplexing (i.e. combining several wavelengths in the same fibre) and demultiplexing (i.e. separating of the different wavelength channels).

It is also necessary to monitor the optical channels for several reasons. One reason is the detection of problems with transmitters or connections indicated by the absence or the low power of one or several channels. Measuring the power in each channel also allows power equalization, which relaxes crosstalk requirements on the demultiplexers. Finally, measuring the channel wavelengths is important since they must stay within defined ranges for which all the demultiplexers and filters in the system are designed. Otherwise signal distortion and/or power loss can occur.

This monitoring is typically achieved with scanning Fabry-Perot interferometers or fixed filters. Fixed filters lack flexibility and, by themselves, cannot distinguish between a power fluctuation and a wavelength drift. A scanning Fabry-Perot has moving parts and requires high precision fabrication and assembly. For lower cost, it is desirable that a monitoring device can be fabricated monolithically. The absence of moving parts should also increase the reliability.

### SUMMARY OF THE PRESENT INVENTION

According to one aspect of the present invention there is provided a system for monitoring wavelength division multiplexed channels in an optical signal, the system comprising:

a phased-array optical wavelength demultiplexer (phasar) device including an input port for receiving an input optical signal, and an output port for transmitting an optical signal, the input and output ports being connected by a waveguide array;

phase control means connected to receive a control signal and operable to vary the effective optical length of each waveguide in the array, such that the phase of optical signals passing through respective waveguides also vary in dependence upon that received control signal;

detector means connected to receive the output optical signal from the phasar device, and operable to produce a detector signal relating to that output optical signal; and

control means connected to receive the detector signal, and operable to supply the control signal to the phase control means, such that a signal from a desired one of the multiplexed channels is output from the phasar device to the detector means.

### BRIEF DESCRIPTION OF THE DRAWINGS

FIG. 1 is a schematic block diagram of a system embodying the present invention;

FIG. 2 is a detailed block diagram of part of the system of FIG. 1;

FIG. 3 illustrates operation of part of the system of FIGS. 1 and 2; and

FIG. 4 illustrates a detailed part of the system of FIGS. 1 and 2.

### DETAILED DESCRIPTION OF THE PREFERRED EMBODIMENT

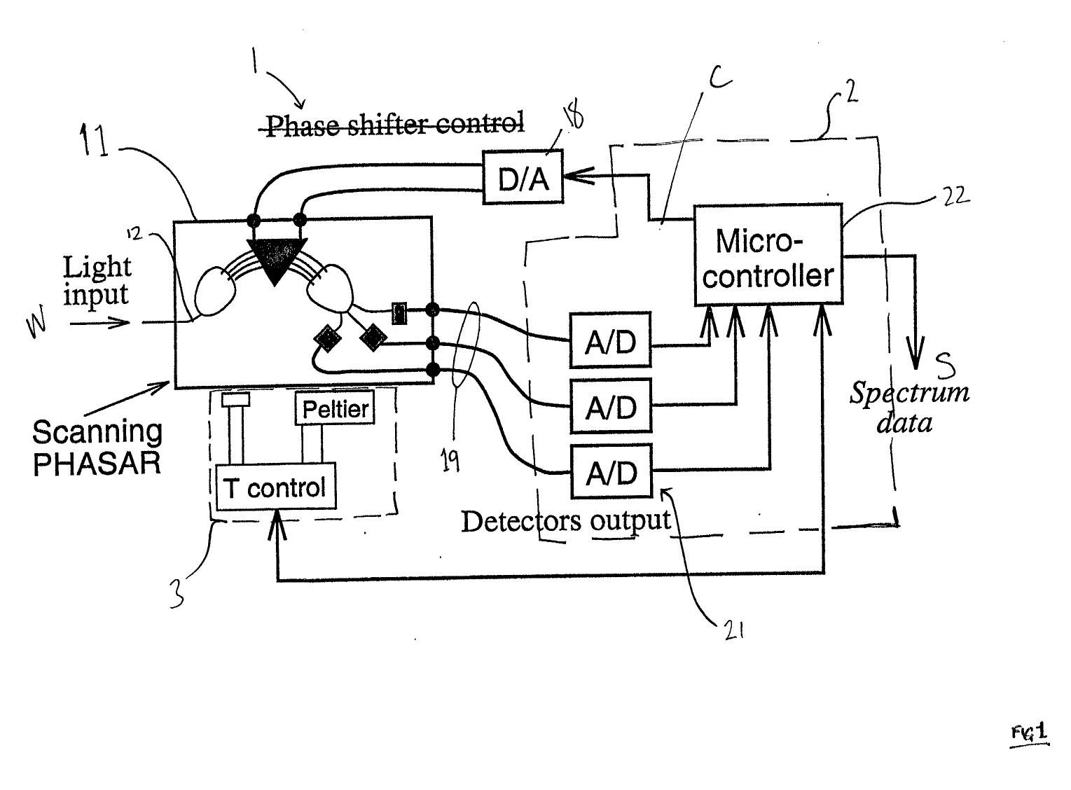

A system embodying the present invention is shown schematically in FIG. 1 of the accompanying drawings, and comprises a phasar device 1, a control unit 2, and a temperature compensation unit 3. The phasar device 1 receives a wavelength division multiplexed (WDM) light input W and outputs a number of detector signals 19 to the control unit 2. The control unit 2 includes a microcontroller 22 which receives digital signals produced from the output signals 19 by analogue to digital convertors 21. The microcontroller outputs spectrum data S and a control signal C.

The control unit 2 produces the control signal C to control the operation of the phasar device in dependence upon the received digital detector signals. The temperature compensation unit produces a temperature-dependent output which is also input to the control unit to provide temperature compensation for the system.

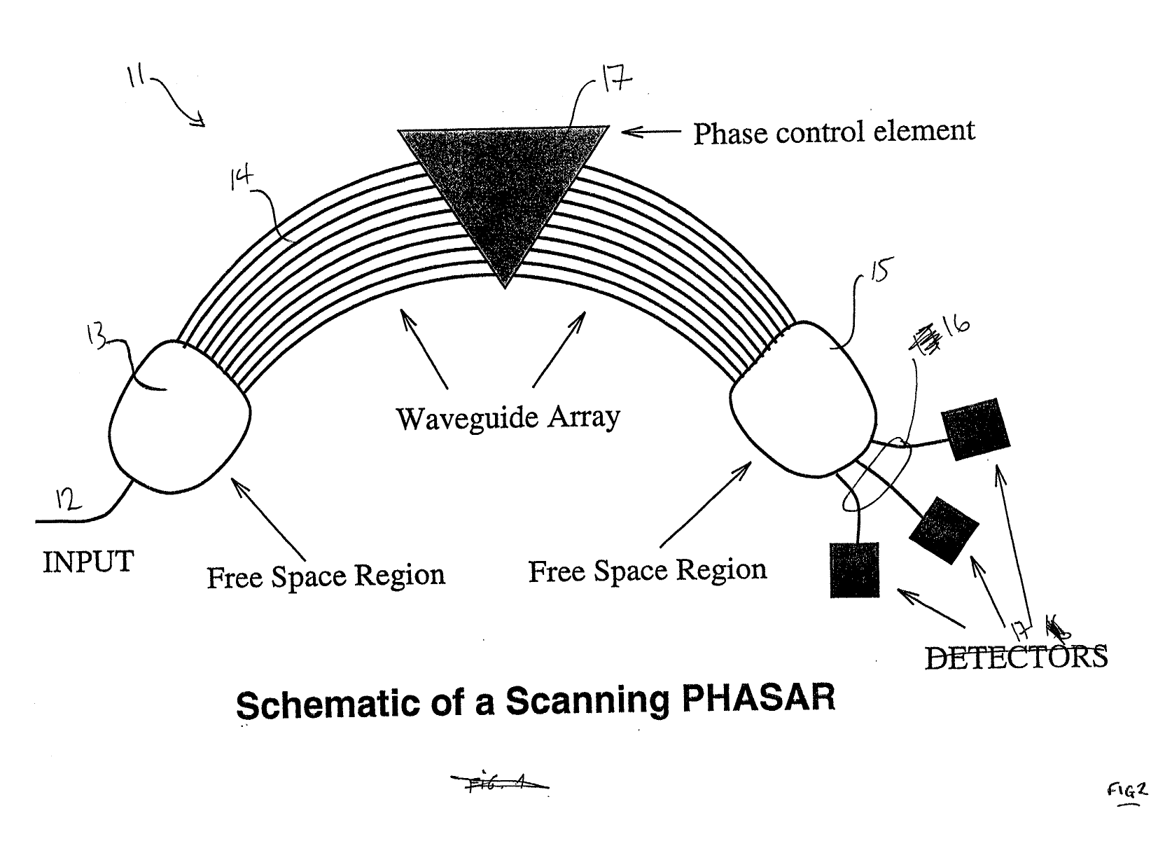

The phasar device 1 itself is well known and is shown in more detail in FIG. 2. The device 1 comprises at least one input waveguide 12 which is connected to an input free propagation region 13. A waveguide array connects the input free propagation region 13 to an output free propagation region 15. The waveguides in the array have a range of lengths and each have a single guided mode of polarization. The output free propagation region 15 is connected to a number of detectors 16 (three in the example shown) by output waveguides. The free propagation regions and waveguide array usually integrated on the same integrated circuit (i.c.). In the free propagation regions, light is guided only in the direction normal to the i.c. surface (i.e. so-called planar optics). the photodetectors may be integrated on the i.c. or may be provided externally.

The structure of the waveguide array, i.e. the range of lengths of the guides, induces different phase changes in light passing through each waveguide.

As is well known, a correct choice of the length differences and the relation between the phase changes in the waveguide array, as well as the dimensions of the free propagation regions and the positions of the waveguide inputs and outputs, is necessary to obtain a working device.

The basic principle of the scanning PHASAR device is to add a scanning function to a standard phased array demultiplexer (or PHASAR), so that the wavelength of the light going to a given output of the demultiplexer changes over a predetermined range.

The design principles of the known PHASAR are described in several books and papers. A good review can be found in M. K. Smit and C. van Damn, “PHASAR-based WDM-devices: Principles, design and applications”, IEEE J. Selected Topics in Quantum Electronics, vol. 2(2), June 1996, pp 236-250, with extensive references. Only the main features will be summarised here for the sake of brevity.

The phased array demultiplexer (PHASAR) works by splitting light coming from the input waveguide 12 between the waveguides of the array 14 by lateral spreading of the beam while it propagates through the input free propagation region 13. Each of the waveguides in the array 14 has a different length Lᵢ, which means that the phase φᵢ for light at a wavelength λ after propagation through that waveguide is given by:

$${φ}_{i} = 2 π \frac{{n}_{e} ( λ )}{λ} {L}_{i} \qquad ( 1 )$$

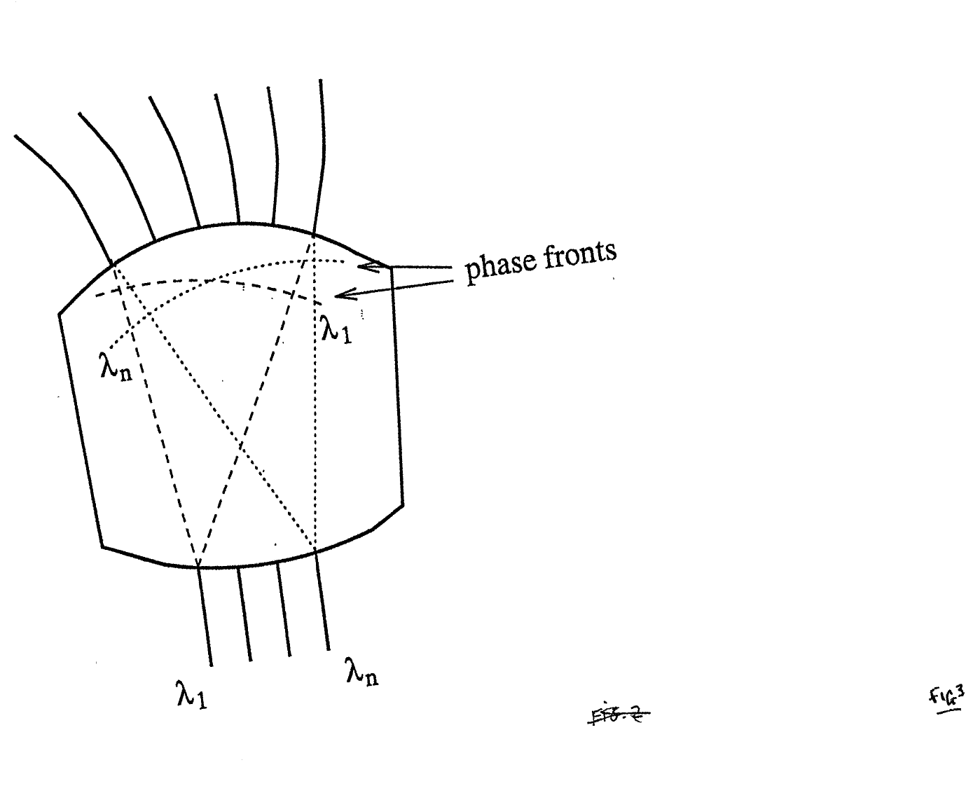

(where nₑ is the effective index for propagation of the guided mode supported by the waveguide). Thus, different wavelengths will acquire different phases. When the light from the different wavelengths are combined in the output free propagation region 15, this phase difference will change the phase fronts and cause the focus point (where all the waves add in phase) to be at a different position for a different wavelength (see FIG. 3).

In practice, the length difference between two adjacent waveguides is always ΔL, giving a phase difference Δφ between adjacent waveguides:

$$Δ L = {L}_{i + 1} - {L}_{i} \\ Δφ = {φ}_{i + 1} - {φ}_{i} = - 2 π \frac{{n}_{e} ( λ )}{λ} Δ L \qquad ( 2 )$$

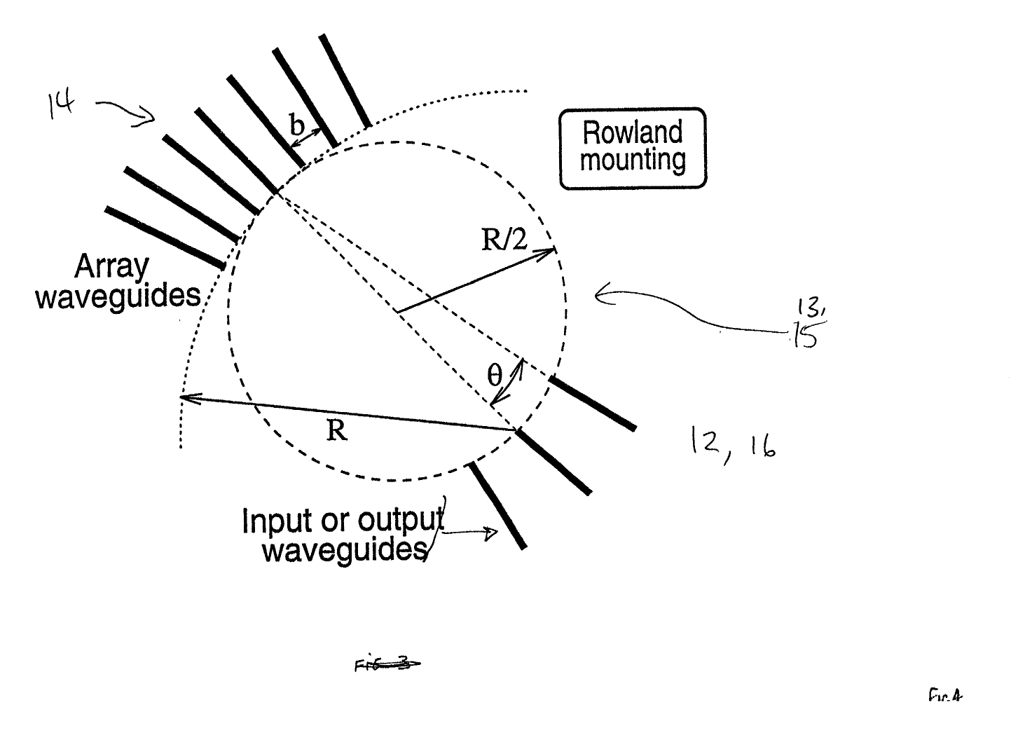

The inputs and outputs of the waveguides in the free propagation regions are positioned in a Rowland-type mounting, as shown in FIG. 4 (other types of mountings are possible). The array waveguide apertures are positioned at a distance b from one another on a circle of radius R and the input (or output) waveguides on the focal line, which is a circle of radius R/2.

In order to get the chosen centre wavelength λ₀ to go to the central output waveguide, the light from all the array waveguides must be in-phase at that position, which is at a distance R from all the array apertures (see FIG. 4). Thus, the phase difference Δφ between adjacent waveguides must be an integer multiple (m) of 2π, which gives:

$$Δ L = m \frac{{λ}_{0}}{{n}_{e} ( {λ}_{0} )} \qquad ( 3 )$$

Given ΔL, we can compute the free spectral range (FSR), which is the period of the demultiplexer since it is the wavelength change that will give a change of Δφ equal to 2π and hence give again an in-phase interference. From equation (2), we get:

$$2 π \frac{δ}{δλ} [ \frac{{n}_{e} ( λ )}{λ} ] {\vert}_{{λ}_{0}} FSR Δ L = 2 π \qquad ( 4 )$$

which gives:

$$FSR = \frac{{λ}_{0}^{2}}{{n}_{g} ( {λ}_{0} ) Δ L} [ m ] \qquad ( 5 )$$

wherein n_{g} is the ground index in the waveguides of the array and is given by:

$${n}_{g} ( λ ) = {n}_{e} ( λ ) - λ \frac{{δn}_{e}}{δλ} \qquad ( 6 )$$

An alternative expression for the FSR as a frequency interval is given by:

$$FSR = \frac{c}{{n}_{g} ( {f}_{0} ) Δ L} [ Hz ] \qquad ( 7 )$$

where c is the speed of light in vacuum and f₀=c/λ₀ [n_{g} is still given by equation (6)].

The change in angle θ (see FIG. 4) that results from a change of Δλ is given by equation (2), due to a deviation of the wavelength from λ₀. A phase difference Δφ corresponds to a propagation length a in the free propagation region given by:

$$a = \frac{Δφ}{{β}_{F}} \qquad ( 8 )$$

where β_{F}=2πn_{F}/λ=2π_{f}f/c, with n_{F} the effective index in the free propagation region. Then, for R>>b, we find that:

$$θ = arcsin ( \frac{a}{b} ) = arcsin ( \frac{Δφ}{{bβ}_{F}} ) \\ \approx \frac{Δφ - m2π}{{bβ}_{F}} \qquad ( 9 )$$

where m is defined by (3).

The dispersion D is defined as the lateral displacement of the focal spot at the output waveguides aperture per unit frequency (or wavelength) change.

Thus, in wavelength, we get:

$$D = \frac{δ ( Rθ )}{δλ} {\vert}_{{λ}_{0}} \approx \frac{R}{b} \cdot \frac{{n}_{g}}{{n}_{F}} \cdot \frac{Δ L}{{λ}_{0}} = \frac{R}{b} \cdot \frac{{λ}_{0}}{{n}_{F}} \cdot \frac{1}{FSR} \qquad ( 10 )$$

where FSR is in meters [m], given by equation (5). In frequency:

$${D}_{f} = \frac{δ ( R θ )}{δ f} {\vert}_{{f}_{0}} \approx \frac{R}{b} \cdot \frac{{n}_{g}}{{n}_{F}} \cdot \frac{Δ L}{{f}_{0}} = \frac{R}{b} \cdot \frac{c}{{n}_{F} {f}_{0}} \cdot \frac{1}{F S R} \qquad ( 11 )$$

where FSR is in Hertz [Hz], given by equation (7).

The light collected in a given output waveguide will have a certain spectral width. The following is a rough analytical estimation of this spectral width. Under the assumption that the number of waveguides in the array 14 is sufficient to sample most of the field profile of the input light diffracted in the input propagation region 13, the output propagation region 15 will produce an image of the input waveguide 12 on the focal line. The light that goes in the filling spaces between the waveguides is just producing a loss. Of course, in reality, the array 14 of waveguides will produce an image that also has side-lobes at other positions. This can cause crosstalk in a demultiplexer.

The field profile of the fundamental mode in a waveguide can be approximated fairly well by a gaussian (see for example [J-P Web, “Device design using gaussian beams and say matrices in planar optics”, IEEE J. Quantum electronics, vol. 30 (10), October 1994 pp 2407-2416, and the Sain and van Dam paper mentioned earlier]). The gaussian beam radius w can be obtained by fitting the gaussian to the real mode profile. Thus, the coupling between the image and the output waveguide we consider is given by the overlap integral between two gaussians with the same width, but centres displaced by d. If the output waveguide is centered at the position corresponding to a certain wavelength wavelength λ₁ and the wavelength of the light is λ₂=λ₁+Δλ, the displacement d is given by:

$$d = R \frac{\partial θ}{\partial λ} Δλ = D Δ λ \qquad ( 12 )$$

where D is the dispersion given by (10). The power coupling between a gaussian beam of radius w and a waveguide mode approximated by a gaussian with the same radius is then given by:

$${C}_{p} ( d ) = exp [ - \frac{{d}^{2}}{{w}^{2}} ] \qquad ( 13 )$$

Thus the half-maximum is obtained for d=W\sqrt{ln2} and using (12), the full-width half-maximum (FWHM) (in[m]), which is the 3 dB bandwidth, is given by:

$$F W H M = 2 \sqrt{ln 2} \frac{w}{D} = 2 \sqrt{ln 2} \frac{{n}_{F} FSR}{{λ}_{0}} \cdot \frac{b}{R} w = 2 \sqrt{ln 2} \frac{{n}_{F}}{{n}_{g}} \cdot \frac{{λ}_{0}}{Δ L} \cdot \frac{b}{R} w \qquad ( 14 )$$

Thus, a good resolution means using a small input and output waveguide width (which gives a small w), a small spacing b of the array waveguides and a large distance R.

For the previous results to be valid, we need enough waveguides in the array to sample the whole field profile. Assuming a gaussian beam, the far-field diffraction angle θ₀ in the free propagation region is given by:

$${θ}_{0} = arctan [ \frac{λ}{π w {n}_{F}} ] \approx \frac{λ}{π w {n}_{F}} \qquad ( 15 )$$

and the far-field profile (in power) is:

$$I ( θ ) = {I}_{0} exp [ - 2 \frac{{θ}^{2}}{{θ}_{0}^{2}} ] \qquad ( 16 )$$

From this, we see that the intensity has fallen to about 1 percent of the maximum when θ=1.5θ₀. Thus, if we take this as the limit, we need to cover an angle θₐ≈3θ₀, which means that the number N of waveguides in the array will be:

$$N \approx \frac{R}{b} {θ}_{a} \approx \frac{3}{π} \cdot \frac{R}{b} \cdot \frac{{λ}_{0}}{w {n}_{F}} \qquad ( 17 )$$

While this is not an exact result, it gives us an order of magnitude and the dependence of N-on the different parameters. We see that N can be reduced with a small R and large b and w, but this will then increase the bandwidth, as seen above.

A more exact way to choose θₐ is given in the Smit and van Dam paper: one can compute the maximum side-lobe intensity as a function of θₐ and then choose θₐ so that the intensity stays below a certain value (typically −35 to −40 dB).

It has been shown above that the condition for a given wavelength λ to couple to a waveguide is given by Δφ=m2π, with m given by equation (3), once the chosen ΔL. As shown above, with Δφ given by equation (2), this sends λ₀ to the centre output waveguide (if the input waveguide was at the centre of the first free propagation region). But, if we add a phase Δψ to Δφ, such that:

$$Δφ = Δψ - 2 π \frac{{n}_{e} ( λ )}{λ} Δ L \qquad ( 18 )$$

the condition Δφ=m2π is not satisfied by λ₀ anymore, but by λ=λ₀+Δλ₀. We can then obtain, to first order that the centre wavelength change Δλ₀ is given by:

$${Δλ}_{0} = \frac{{λ}_{0}^{2} Δ}{{n}_{8} Δ L} \cdot \frac{Δψ}{2 π} = F S R \frac{Δψ}{2 π} \qquad ( 19 )$$

By tuning Δψ between 0 and 2π, the full free spectral range. If there are N waveguides, in waveguide i(i=1, . . . , N) an additional phase shift ιᵢ must be induced which is equal to i times Δψ. Thus, in waveguide number N, there must be a phase change ψ_{N}=NΔψ.

PHASARs are polarization independent if the optical path length in the array waveguides is equal for the TE (transverse electric) and TM (transverse magnetic) polarizations, which means that the effective indices must be the same (i.e. there is no birefringence). Other methods can be used, such as order matching where one makes the diffraction order m for TE coincide with order m−1 for TM. Polarization compensation solves the problem by inserting a section with a different birefringence in each waveguide. One can also use polarization splitting and inject the TE and TM light in different input waveguides so that the output waveguide is the same. Finally, one can insert a half-wave plate in the middle of the PHASAR (at the symmetry line), which will exchange TE and TM and give the same phase change to the two modes for any waveguide birefringence.

The function of a system embodying the present invention is to monitor a WDM link by measuring the wavelength and power of all the channels present in the fibre (in a certain wavelength range). For this device to work correctly, it must be polarization independent since the polarization of the light in the fibre is random, changing over time and probably different at different wavelengths.

If a WDM signal is injected into an input waveguide, the power Pⱼ in an output waveguide j is given by:

Pⱼ=∫|Tⱼ(λ)|²S(λ)dλ (20)

where S(λ) is the power spectrum of the WDM signal and Tⱼ(λ) is the (amplitude) transmission between the input and output j. As shown above, a first approximation to the transmission function is given by the gaussian:

$$\begin{matrix}\vert {T}_{j} ( λ ) {\vert}^{2} \approx \vert {T}_{0} ( {λ}_{0} ) {\vert}^{2} exp ( - {[ \frac{D Δ λ}{w} ]}^{2} ) \\ \approx \vert {T}_{0} ( {λ}_{0} ) {\vert}^{2} exp ( - {[ \frac{R}{w b} \cdot \frac{{λ}_{0}}{{n}_{f}} \cdot \frac{Δλ}{F S R} ]}^{2} )\end{matrix} \qquad ( 21 )$$

where λ=λ₀+Δλ. If the centre wavelength is scanned by adding a phase change Δψ to Δφ, to first order the shape of |Tⱼ(λ)|² is not modified, but only the centre wavelength λ₀ is changed. The change Δλ₀ is a function of Δψ and is given by equation (19). The power Pⱼ(Δλ₀) in the output waveguide is then given by:

Pⱼ(Δλ₀)=∫|Tⱼ(λ₀−Δλ₀+Δλ)|²S(λ₀+Δλ)d(Δλ) (22)

i.e. the power spectrum as a function of the scanning Δλ₀ is the convolution of the input power spectrum with the transmission spectrum.

If the resolution of the transmission function is sufficient, it can be approximated by a delta function and one can then obtain directly a measurement of the input power spectrum by scanning Δλ. In that case:

Pⱼ(Δλ₀)≈|T₀|²S(λ₀+Δλ₀) (23)

Otherwise standard numerical methods can be used to recover the WDM power spectrum, if the transmission function is known. And the transmission function can be measured using for example a single-mode tunable external cavity laser (which is a good approximation of a delta function, this time for S(λ)). In all cases, the absolute power and wavelength can be calibrated using a source with known power and wavelength.

Although the above description is concerned with a single output waveguide, it is possible to have several output waveguides. Each of them will then have a different centre wavelength and see a different part of the spectrum when the spectrum is scanned. This has the advantage that the whole free spectral range FSR need not be scanned, but only about FSR/q, if q is the number of output waveguides and their centre wavelengths are equally spaced over the FSR. Each of them would usually require separate calibration.

Most of the usual design considerations of PHASARs for reducing losses and crosstalk apply also to embodiments of the present invention. However, a flattened response is not desirable. On the contrary, as narrow a response as possible is preferred for better wavelength resolution. Notice that in all cases, the substrate temperature must be stabilized in order to avoid changes of the centre wavelength due to thermal drift. The temperature compensation circuit is able to do this.

An embodiment of the present invention uses the phase control unit to induce an additional, variable, phase difference Δψ. As results from the above, this means adding a phase ψᵢ=iΔψ in array waveguide i. This phase change can be obtained by changing the refractive index of a section of waveguide. If we assume that the effective index change Δnₑ is uniform, the phase change is then proportional to the length of the section where we change the index. This will give:

$${ψ}_{i} \approx - \frac{2 π}{{λ}_{0}} Δ {n}_{e} ( i δ ) \qquad ( 24 )$$

The methods that can be used to change the refractive index depends on the material used for the waveguides. The possible methods include: the photo-elastic effect (mainly the acousto-optic effect), the magneto-optic effect, the electro-optic effect is not practical for integrated optics. The acoustic-optic effect cannot give a constant index change, which is necessary in this device. The electro-optic effect has been widely used, both in crystals such as LiNbO₃ and in semiconductors (Stark effect in bulk or quantum-wells), for retractive index changes in other devices. The plasma effect relies on the refractive index change due to carrier injection (electrons and holes in a material). This causes a change in the absorption spectrum and thus a change in the refractive index (by the Kramers-Kroenig relation). The problem with these two effects (in semiconductors) is that they need to use a p-i-n diode structure, either reverse biased (electro-optic effect) or forward biased (plasma effect). This means that doped materials are needed and thus free carrier absorption (especially for the p-doped material) will occur. In addition, for the plasma effect, the injected carriers also contribute to absorption problems. This can make it difficult to get low loss devices, and in the carrier injection case, the loss increases proportionally to the index change. If the Stark effect is used in bulk or quantum-wells, there is also an increase of absorption when the index change increases. These effects will thus give loss differences between the different waveguides which will cause imperfect reconstruction in the second free propagation region and thus crosstalk.

Therefore, the best method to control the refractive index is the thermo-optical effect, especially if switching speed is not important. Some of the advantages are: there is no need to dope the material (it can even be an insulator) and there is thus no free carrier absorption, there is negligible variation of the losses with index change, there is potential for better reliability (since no current induced damage occurs in the material) and there is very little wavelength dependence. Such a method is also suitable for most materials used for integrated optics.

In practice, the phase control is preferably achieved by controlling the temperature of sections of waveguides with a thin-film heater deposited on top of the waveguides and keeping the bottom of the substrate at a constant temperature. The heater layout must be designed so that the resulting temperature distribution gives the desired index changes.

Only one heater is needed to realize all the phase changes at the same time. The heated area would probably look like the triangle shown in FIG. 1. The only problem with this solution is the relatively slow switching speed (milliseconds time scale). If switching speed is important, the electro-optic effect could be used, although care should be taken that the index change does not depend too much on wavelength (especially if quantum wells are used).

The materials to be used depend on the way the phase control elements are implemented, and if on-chip photo-detectors (monolithically integrated) are required. If the plasma effect or the electro-optic effect (in a semiconductor) is used, either AlGaAs/GaAs or InGaAsP/InP (or a similar material system) should be used. The electro optic effects suggest that LiNbO₃ and maybe some polymers should be used. Having on-chip detectors means using a direct bandgap semiconductor system such as AlGaAs/GaAs or InGaAsP/InP for the long wavelength region (1.3 μm or 1.55 μm). At shorter wavelengths, Si can be used.

The thermo-optic effect allows the largest choice of materials: semiconductors (like AlGaAs/GHaAs or InGaASP/InP, LiNbO_{3,} polymers, but also SiO₂/Si. The main differences between these materials will be their refractive index, available index steps, the value of their thermo-optic coefficients (δn/δT) and the propagation losses. This will influence mainly the size of the resulting device.

As mentioned above, it is possible to use several output waveguides. This can be advantageous, mainly for the following two reasons:

1. Since each of the q outputs scans a fraction 1/q of the free spectral range, the maximum Δψ needed is only 2π/q, which reduces the length of the phase change sections and/or the magnitude of the index change needed.

2. Since we are scanning only a fraction 1/q of the range, for the same rate of change of the phase the time will also be reduced by a factor q.

The disadvantages are that there are now several detectors which must be read and their outputs combined to give the final result. This can mean slightly more complex and expensive post-processing. However, modern micro-electronics enables the solution to be produced with a single A/D converter per detector.

For maximum simplicity, a monolithic integration of the detectors is preferably. If we want to work at 1.3 μm or 1.55 μm (the typical telecommunication wavelengths), the best present material choice is probably InGaAsP/InP. PHASARs have been realized in this material system for operation around 1.55 μm, with 8 channels and a FSR of about 700 GHz (5.6 nm), or with 16 channels and a FSR of about 30 nm.

An embodiment of the invention uses a similar layout, but with only a few output waveguides (maybe 3 or 4). A heater is added to the device on top of the waveguide array. The shape of this heater is calculated to give the desired linear relation between the induced phase changes in the waveguides. If we use for example 4 output waveguides, we need a maximum Δψ of π/2. Typical values for waveguides on InP are nₑ≈ and δnₑ/δT ≈10⁻⁴ [K⁻¹], which leads to a π/2 phase change being obtained by increasing a 40 μm long section of waveguide by about 30 degrees. This is no problem, since the typical waveguide length difference ΔL is larger than this (this should nevertheless be checked when this device is designed). Even if it is not, the longest waveguide can be made long enough to contain the longest phase change section (which is N times the basic section length, where N is typically on the order of 50).

As shown in FIG. 1, the photo-detectors are then connected to A/D converters (possibly through amplifiers) and the heater is controlled by a D/A converter. The substrate temperature is measured by a thermistor and stabilized with a Peltier element by using a feedback loop. The whole device is controlled by a micro-controller that can also do the numerical processing to reconstruct the WDM signal spectrum. The calibration data can be stored in permanent memory by the micro-controller.

1. A system for monitoring wavelength division multiplexed channels in an optical signal, the system comprising:
a phased-array optical wavelength demultiplexer (phasar) device including an input port for receiving an input optical signal, and an output port for transmitting an optical signal, the input and output ports being connected by a waveguide array;
phase control means connected to receive a control signal and operable to vary the effective optical length of each waveguide in the array, such that the phase of optical signals passing through respective waveguides also vary in dependence upon that received control signal;
detector means connected to receive the output optical signal from the phasar device, and operable to produce a detector signal relating to that output optical signal; and
control means connected to receive the detector signal, and operable to supply the control signal to the phase control means, such that a signal from a desired one of the multiplexed channels is output from the phasar device to the detector means.

2. A system as claimed in claim 1, wherein the phase control means are provided by a heater device which acts on the waveguides in the waveguide array, thereby to vary the temperature of the waveguides.

3. A system as claimed in claim 1, wherein the phase control means are operable to cause an acousto-optic effect in the waveguides of the array.

4. A system as claimed in claim 1, wherein the phase control means are operable to cause an electro-optic effect in the waveguides of the array.

5. A system as claimed in claim 1, wherein the phase control means are operable to cause a magneto-optic effect in the waveguides of the array.

6. A system as claimed in claim 1, wherein the phase control means are operable to cause a plasma effect in the waveguides of the array.

7. A system as claimed in claim 1, wherein the phasar device, phase control means and detector means are integrated on a single integrated device.

8. A system as claimed in claim 1, comprising compensation means for adjusting the control signal on the basis of the temperature of the phasar device.
